(19) United States
(12) Patent Application Publication
(10) Pub. No.: US 2019/0011991 A1
(43) Pub. Date: Jan. 10, 2019

(54) ELECTRONIC DEVICE AND METHOD FOR CONTROLLING DISPLAY

(71) Applicant: HON HAI PRECISION INDUSTRY CO., LTD., New Taipei (TW)

(72) Inventors: CHIN-PIN KUO, New Taipei (TW); CHIH-TE LU, New Taipei (TW); JUNG-YI LIN, New Taipei (TW); TUNG-TSO TSAI, New Taipei (TW); JUNG-HAO YANG, New Taipei (TW); I-HUA CHEN, New Taipei (TW)

(21) Appl. No.: 15/859,742

(22) Filed: Jan. 2, 2018

(30) Foreign Application Priority Data
Jul. 6, 2017 (TW) 106122749

(51) Int. Cl. G06F 3/01; G06F 3/16

(52) U.S. Cl. CPC G06F 3/017; G06F 3/167

(57) ABSTRACT

An electronic device and a method therefor is applied to controlling a display. The method includes acquiring control operations of a user and determining that a first control instruction has been given according to relationship between predetermined control operations and control instructions stored in a storage device. Method also determines whether such first control instruction requires a switch to be made according to a predetermined condition. Upon determining that the control operations satisfy the predetermined condition and that a switch in instruction is required, switching to a second instruction in place of the first instruction according to the predetermined instruction switching rule of the state switching device in a current state. A function corresponding to the second control instruction is activated in place of the first instruction if the state-switch is to be made.

### CROSS-REFERENCE TO RELATED APPLICATIONS

This application claims priority to Taiwanese Patent Application No. 106122749 filed on Jul. 6, 2017, the contents of which are incorporated by reference herein.

### FIELD

The subject matter herein generally relates to display control technology, and particularly to an electronic device and a method for controlling a display.

### BACKGROUND

Large screen display system is widely used in advertising, video conferencing, and household video with advantage of intuition and openness. Gesture or voice is usually used for controlling the large screen display system. However, gesture control takes time and can be complex, and gesture control and voice control are not effectively combined.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of an exemplary embodiment of an electronic device.

FIG. 2 is a table illustrating relationship between states relating to a state switching device and control instructions of an exemplary embodiment .

FIG. 3 illustrates a flowchart of an exemplary embodiment of a method for controlling a display.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one.”

Furthermore, the term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series, and the like.

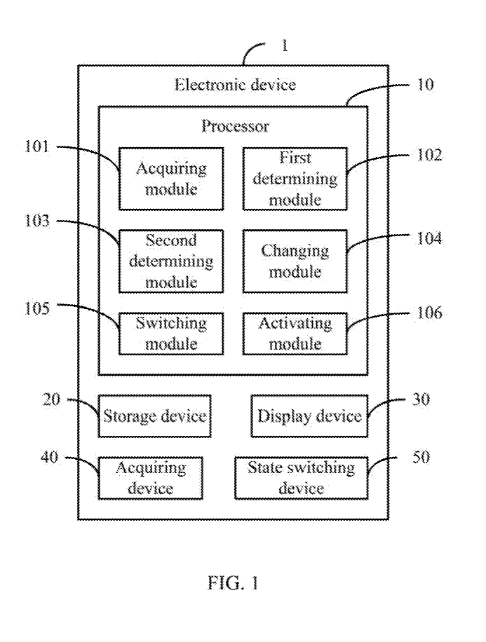

FIG. 1 illustrates an exemplary embodiment of an electronic device 1. The electronic device 1 includes, but is not limited to, a processor 10, a storage device 20, a display device 30, an acquiring device 40, and a state switching device 50. In at least one exemplary embodiment, the electronic device 1 can be a personal computer, a smart television, or multiple televisions forming a display wall. FIG. 1 illustrates only one example of the electronic device 1, other examples can include more or fewer components than illustrated, or have a different configuration of the various components in other embodiments.

In at least one exemplary embodiment, the storage device 20 can include various types of non-transitory computer-readable storage mediums. For example, the storage device 20 can be an internal storage system, such as a flash memory, a random access memory (RAM) for temporary storage of information, and/or a read-only memory (ROM) for permanent storage of information. The storage device 20 can also be an external storage system, such as a hard disk, a storage card, or a data storage medium. The processor 10 can be a central processing unit (CPU), a microprocessor, or other data processor chip that performs functions of the electronic device 1.

In at least one exemplary embodiment, the storage device 20 stores relationship between predetermined control operations and control instructions. The predetermined control operations include voice and/or gestures. For example, voice content “Look here” corresponds to an instruction of starting input, voice content “stand-by” corresponds to an instruction of finishing input, voice content “Play (name of movie or name of song)” corresponds to an instruction of playing the named movie or song, a gesture of waving upwards corresponds to an instruction of moving up, a gesture of waving downwards corresponds to an instruction of moving down, a gesture of waving to the left corresponds to an instruction of moving left, and a gesture of waving to the right corresponds to an instruction of moving right.

In at least one exemplary embodiment, the display device 30 can be a liquid crystal display (LCD) or an Active Matrix/Organic Light Emitting Diode (AMOLED) display. The display device 30 is used for displaying a user interface and media data of the electronic device 1.

In at least one exemplary embodiment, the acquiring device 40 at least includes a microphone and/or a camera. The microphone is used for acquiring voice of a user. The camera is used for capturing gestures of the user.

In at least one exemplary embodiment, the state switching device 50 is a state switching element. The state switching device 50 can include a number of state registers and combinational logic circuits. The state switching device 50 is used for switching between control instructions according to a predetermined state switching rule. In at least one exemplary embodiment, the state switching device 50 has a number of states, and each state corresponds to a predetermined instruction switching rule. The state switching device 50 can switch between the control instructions according to the predetermined instruction switching rule.

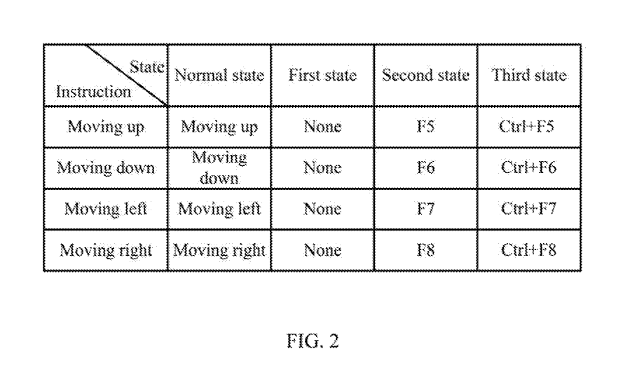

Referring to FIG. 2, for example, the state switching device 50 has a normal state, a first state, a second state, and a third state. An initial state of the state switching device 50 is the normal state. In the normal state, the state switching device 50 does not switch between the control instructions. In the first state, the state switching device 50 ignores the control instructions. In the second or third state, the state switching device 50 switches from control instructions to other predetermined instructions according to the predetermined instruction switching rule.

As illustrated in FIG. 1, the electronic device 1 includes an acquiring module 101, a first determining module 102, a second determining module 103, a changing module 104, a switching module 105, and an activating module 106. The modules 101-106 can be collections of software instructions stored in the storage device 20 of the electronic device 1 and executed by the processor 10. The modules 101-106 also can include functionality represented as hardware or integrated circuits, or as software and hardware combinations, such as a special-purpose processor or a general-purpose processor with special-purpose firmware.

The acquiring module 101 is used to control the acquiring device 40 to detect and acquire a control operation of the user. In at least one exemplary embodiment, the acquiring module 101 can control the microphone to acquires the voice of the user, and control the camera to acquire the gesture of the user. That is, the control operation of the user can be expressed as voice of the user or as gesture of the user.

The first determining module 102 is used to determine a first control instruction which corresponds to the acquired control operations of the user, according to the relationship between the predetermined control operations and the control instructions stored in the storage device 20.

The second determining module 103 is used to determine whether the first control instruction is for changing a current state of the state switching device 50.

In at least one exemplary embodiment, the instructions for changing the current state of the state switching device 50 are voice instructions, and the actual words corresponding to the voice instructions can include “Normal state”, “First state”, “Second state”, and “Third state”.

When the second determining module 103 determines that the first control instruction is for changing the current state of the state switching device 50, the changing module 104 changes the current state of the state switching device.

For example, when the actual words acquired by the acquiring device 40 is “Normal state”, the changing module 104 changes the current state of the state switching device 50 to the normal state.

In other exemplary embodiments, the display device 30 can also display a state defining interface (not shown), by which the user can manually define the state of the state switching device 50.

When the second determining module 103 determines that the first control instruction is not for changing the current state of the state switching device 50, the second determining module 103 is further used to determine whether the control operations satisfy a predetermined condition.

In at least one exemplary embodiment, the predetermined condition is that a duration of the control operation is greater than or equal to a predetermined time period. That is, the second determining module 103 determines whether the duration of the control operation is greater than or equal to the predetermined time period. If the duration of the control operation is greater than or equal to the predetermined time period, the first control instruction is taken as requiring a switch to another instruction. If the duration of the control operation is less than the predetermined time period, the first control instruction is not taken as a state switching requirement. In at least one exemplary embodiment, the predetermined time period is five seconds. In other exemplary embodiments, the predetermined time period can be any other suitable value.

In another exemplary embodiment, the predetermined condition is that a quantity of individual control operations is greater than or equal to a predetermined value. That is, the second determining module 103 determines whether the quantity of the control operations is greater than or equal to the predetermined value. If the quantity of the control operations is greater than or equal to the predetermined value, the first control instruction is taken as requiring a switch. If the quantity of the control operations is less than the predetermined value, the first control instruction is not so taken. In at least one exemplary embodiment, the predetermined value is three. In other exemplary embodiments, the predetermined value can be any other suitable value.

If the second determining module 103 determines that the first control instruction does require a switch in instruction, the switching module 105 is used to switch the first instruction to a second instruction according to the predetermined instruction switching rule of the state switching device 50 in the current state.

As illustrated in FIG. 2, for example, when the current state of the state switching device 50 is the second state, the switch in instruction causes the switching module 105 to switch a moving up instruction, a moving down instruction, a moving left instruction, and a moving right instruction to respective instructions of F5, F6, F7, and F8 functions.

If the second determining module 103 determines that the first control instruction does not require a switch in instruction, the activating module 106 controls the display device 30 to activate a function corresponding to the first control instruction. If the second determining module 103 determines that the first control instruction does require a switch in instruction, the activating module 106 controls the display device 30 to activate a function corresponding to the second control instruction.

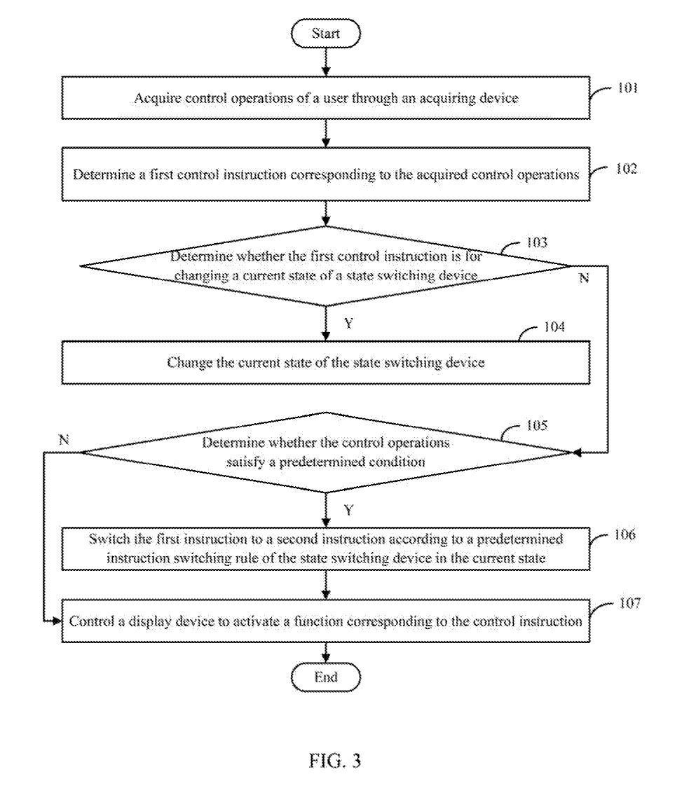

FIG. 3 illustrates a flowchart of an exemplary embodiment of a method for controlling a display. The method is provided by way of example, as there are a variety of ways to carry out the method. The method described below can be carried out using the configurations illustrated in FIG. 1, for example, and various elements of these figures are referenced in explaining the example method. Each block shown in FIG. 3 represents one or more processes, methods, or subroutines carried out in the example method. Furthermore, the illustrated order of blocks is by example only and the order of the blocks can be changed. Additional blocks may be added or fewer blocks may be utilized, without departing from this disclosure. The example method can begin at block 101.

At block 101, an acquiring module controls an acquiring device to detect and acquire control operations of a user.

At block 102, a first determining module determines a first control instruction corresponding to the acquired control operations of the user, according to relationship between predetermined control operations and control instructions stored in a storage device.

At block 103, a second determining module determines whether the first control instruction is for changing a current state of a state switching device. If the first control instruction is for changing the current state of the state switching device, the process jumps to block 104. If the first control instruction is not for changing the current state of the state switching device, the process jumps to block 105.

At block 104, a changing module changes the current state of the state switching device.

At block 105, the second determining module further determines whether the control operations satisfy a predetermined condition. If the control operations satisfy the predetermined condition, the process jumps to block 106. If the control operations do not satisfy the predetermined condition, the process jumps to block 107.

In at least one exemplary embodiment, the predetermined condition is that a duration of the control operation is greater than or equal to a predetermined time period. In another exemplary embodiment, the predetermined condition is that a quantity of the control operations is greater than or equal to a predetermined value.

At block 106, a switching module switches the first instruction to a second instruction according to a predetermined instruction switching rule of the state switching device in a current state.

At block 107, an activating module controls a display device to activate a function corresponding the control instruction.

In detail, when the control operations do not satisfy the predetermined condition, the second determining module determines that the first control instruction does not require a switch in instruction, the activating module controls the display device to activate a function corresponding to the first control instruction. When the control operations satisfy the predetermined condition, the second determining module determines that the first control instruction does require a switch in instruction, the activating module controls the display device to activate a function corresponding to a second control instruction.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

1. An electronic device comprising:
at least one processor,
an acquiring device coupled to the at least one processor;
a state switching device coupled to the at least one processor and having a plurality of states, wherein each state corresponds to a predetermined instruction switching rule; and
a storage device coupled to the at least one processor and storing instructions for execution by the at least one processor to cause the at least one processor to:
control the acquiring device to acquire control operations of a user,
determine a first control instruction corresponding to the acquired control operations of the user, according to a relationship between predetermined control operations and control instructions stored in the storage device;
determine whether the first control instruction is for changing the current state of the state switching device;
change, when determining that the first control instruction is for changing the current state of the state switching device, the current state of the state switching device;
determine, when determining that the first control instruction is not for changing the current state of the state switching deviceₛ whether the control operations satisfy a predetermined condition;
switch, when determining that the control operations satisfy a predetermined condition, the first control instruction to a second control instruction according to the predetermined instruction switching rule of the state switching device in a current state; and
control a display device of the electronic device to activate a function corresponding to the second control instruction.

2. The electronic device according to claim 1, wherein the at least one processor is further caused to:
control, when determining that the control operations do not satisfy a predetermined condition, the display device to activate a function corresponding to the first control instruction.

3. (canceled)

4. The electronic device according to claim 1, wherein the predetermined condition is that a duration of the control operation is greater than or equal to a predetermined time period.

5. The electronic device according to claim 1, wherein the predetermined condition is that a quantity of the control operations is greater than or equal to a predetermined value.

6. The electronic device according to claim 1, wherein the acquiring device comprises a microphone and a camera, the predetermined control operations comprises voice and gestures, the microphone is used for acquiring voice of the user, and the camera is used for capturing gestures of the user.

7. The electronic device according to claim 1, wherein the state switching device comprises a plurality of state registers and combinational logic circuits, the state switching device is used for switching between control instructions according to a predetermined state switching rule.

8. A method for controlling a display comprising:
acquiring control operations of a user through an acquiring device of an electronic device;
determining a first control instruction corresponding to the acquired control operations of the user, according to a relationship between predetermined control operations and control instructions stored in a storage device of the electronic device;
determining whether the first control instruction is for changing the current state of the state switching device;
when determining that the first control instruction is for changing the current state of the state switching device, changing the current state of the state switching device;
when determining that the first control instruction is not for changing the current state of the state switching device, determining whether the control operations satisfy a predetermined condition;
when determining that the control operations satisfy the predetermined condition, switching the first control instruction to a second control instruction according to the predetermined instruction switching rule of a state switching device in a current state; and
controlling a display device of the electronic device to activate a function corresponding to the second control instruction.

9. The method according to claim 8, further comprising:
when determining that the control operations do not satisfy the predetermined condition, controlling the display device to activate a function corresponding to the first control instruction.

10. (canceled)

11. The method according to claim 8, wherein the predetermined condition is that a duration of the control operation is greater than or equal to a predetermined time period.

12. The method according to claim 8, wherein the predetermined condition is that a quantity of the control operations is greater than or equal to a predetermined value.

13. The method according to claim 8, wherein the acquiring device comprises a microphone and a camera, the predetermined control operations comprises voice and gestures, the microphone is used for acquiring voice of the user, and the camera is used for capturing gestures of the user.
